(19) United States
(12) Patent Application Publication
(10) Pub. No.: US 2019/0155954 A1
(43) Pub. Date: May 23, 2019

(54) Cognitive Chat Conversation Discovery

(71) Applicant: International Business Machines Corporation, Armonk, NY (US)

(72) Inventors: Munish Goyal, Yorktown Heights, NY (US); Wing L. Leung, Austin, TX (US); Sarbajit K. Rakshit, Kolkata (IN); Kimberly G. Starks, Nashville, TN (US)

(21) Appl. No.: 15/818,087

(22) Filed: Nov. 20, 2017

(51) Int. Cl. G06F 17/30; G06N 5/02

(52) U.S. Cl. CPC G06F 17/30867; G06N 5/022; G06F 17/30991

(57) ABSTRACT

An approach is provided that transmits posts between users, with the posts being directed to a discussion stored in a storage area. The approach identifies topics corresponding to the posts. The identifying is performed by ingesting the posts into a QA system, deriving information from the posts, and posing a questions to the QA system regarding topic commonality between the posts. The approach analyzes responses and scores from the QA system to match a topic found in one of the posts with the topic also found other posts. The topics are displayed at a selected the devices utilized one of the users.

### BACKGROUND OF THE INVENTION

### Description of Related Art

Multi-person Instant Message chats often become very crowded with different conversation topics. Some participants on the chat session may discuss one topic of interest amongst themselves, while another group of participants discuss a separate topic. Simultaneous discussions on different topics lead to confusion and ambiguity. Because chat topics are intermingled, participants have to read all messages, resolve any ambiguous text, and determine which messages are relevant to their interests. Information that is incorrectly understood gets lost in the chat background, and users experience decreased productivity because of the time required to examine older messages on unimportant topics.

In many of today's social applications or even the comments section of a news website, users can post responses (both graphic and textual content) to a parent topic (e.g., breaking news, review of a new gadget, discussion forum for an upcoming movie, etc.) In many instances, these linear, list-like, sequential posts aren't independent comments but form threads of conversation that are difficult to follow by interested readers simply due to the massive volume and the disconnected/ad-hoc nature of the posts. Traditional systems fail to provide an interested party with an organized view of this content based on the actual threads of conversation.

### SUMMARY

An approach is provided that transmits posts between users, with the posts being directed to a discussion stored in a storage area. The approach identifies topics corresponding to the posts. The identifying is performed by ingesting the posts into a QA system, deriving information from the posts, and posing a questions to the QA system regarding topic commonality between the posts. The approach analyzes responses and scores from the QA system to match a topic found in one of the posts with the topic also found other posts. The topics are displayed at a selected the devices utilized one of the users.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a processor and components of an information handling system;

FIG. 2 is a network environment that includes various types of information handling systems interconnected via a computer network;

FIG. 3 is a diagram system interaction diagram depicting interaction between electronic message contributors and an electronic chat system;

FIG. 4 is a diagram depicting functions of the topic analyzer and sub-group creator;

FIG. 5 is a flowchart showing steps taken to process dialogs found in electronic messaging systems;

FIG. 6 is a flowchart showing steps taken to process a given post found in a dialog and create new topics and add posts to existing topics;

FIG. 7 is a flowchart showing steps that use the post processing to create topic summaries and highlights;

FIG. 8 is a flowchart showing steps taken to handle the electronic messaging display that incorporates topic segregation;

FIG. 9 is a flowchart showing steps taken to discover new topics that are discussed in an online discussion;

FIG. 10 is a flowchart showing steps taken to process data using a QA system to discover new topics that are discussed in an online discussion;

FIG. 11 is a flowchart showing steps taken to ingest discussion data into a QA system; and

FIG. 12 is a flowchart showing steps taken to use crowd-based domain corpora integration when ingesting data into the QA system.

### DETAILED DESCRIPTION

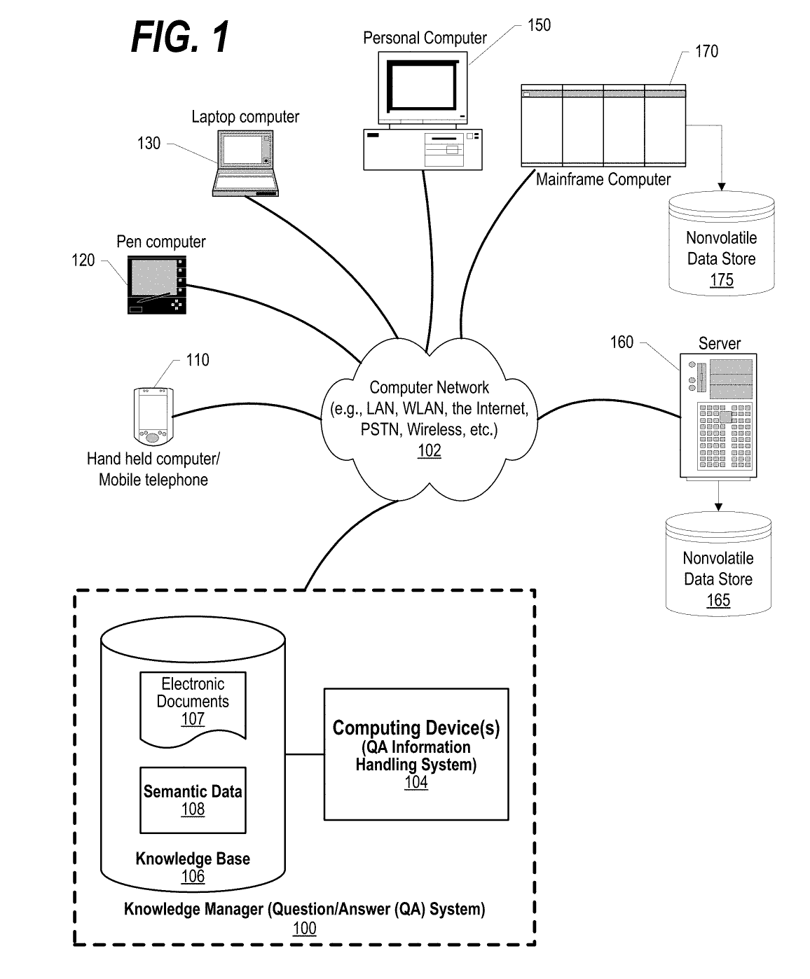

FIGS. 1-12 describe an approach that provides a cognitive system and method to turn disorganized, unstructured, chat room/blog/channel style user posts into organized, structured, conversations for easier consumption. The approach provides a system and methods by which a cognitive application ingests a description of the general channel or topic of conversation. Leveraging natural language and cognitive capabilities, the application can derive information such as the topics and concepts of discussion. The description can be from a general description of the channel, a parent story or post to which users are commenting, and extraction of data from associated images.

A cognitive application processes individual user posts. Leveraging natural language and cognitive capabilities to derive additional information about the post such as key concepts, entities, relationship, etc. A cognitive application then applies heuristic matching and either decides that the post is a new or independent and create a new conversation from it, or matches and associates it to an existing conversation. A cognitive application then presents the conversational view of the user posts providing any user with additional insights into user conversations around the topic.

Providing a conversational view of disorganized, chat room style comments/posts is different from traditional systems. Applying advanced natural language processing and cognitive functions to dynamically organize chat room style comments/posts into conversations assists the user in following topics of interest and organizing the material in a meaningful manner. Educational solutions, especially online educational offerings benefit from the approach's ability to manage open comments about courses. The ability to turn those open comments into organized conversations for better feedback and course improvement would serve the students.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of a question/answer creation (QA) system 100 in a computer network 102. QA system 100 may include a knowledge manager computing device 104 (comprising one or more processors and one or more memories, and potentially any other computing device elements generally known in the art including buses, storage devices, communication interfaces, and the like) that connects QA system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments of QA system 100 may be used with components, systems, sub-systems, and/or devices other than those that are depicted herein.

QA system 100 may be configured to receive inputs from various sources. For example, QA system 100 may receive input from the network 102, a corpus of electronic documents 107 or other data, a content creator, content users, and other possible sources of input. In one embodiment, some or all of the inputs to QA system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with QA system 100. Electronic documents 107 may include any file, text, article, or source of data for use in QA system 100. Content users may access QA system 100 via a network connection or an Internet connection to the network 102, and may input questions to QA system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. QA system 100 may interpret the question and provide a response to the content user containing one or more answers to the question. In some embodiments, QA system 100 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

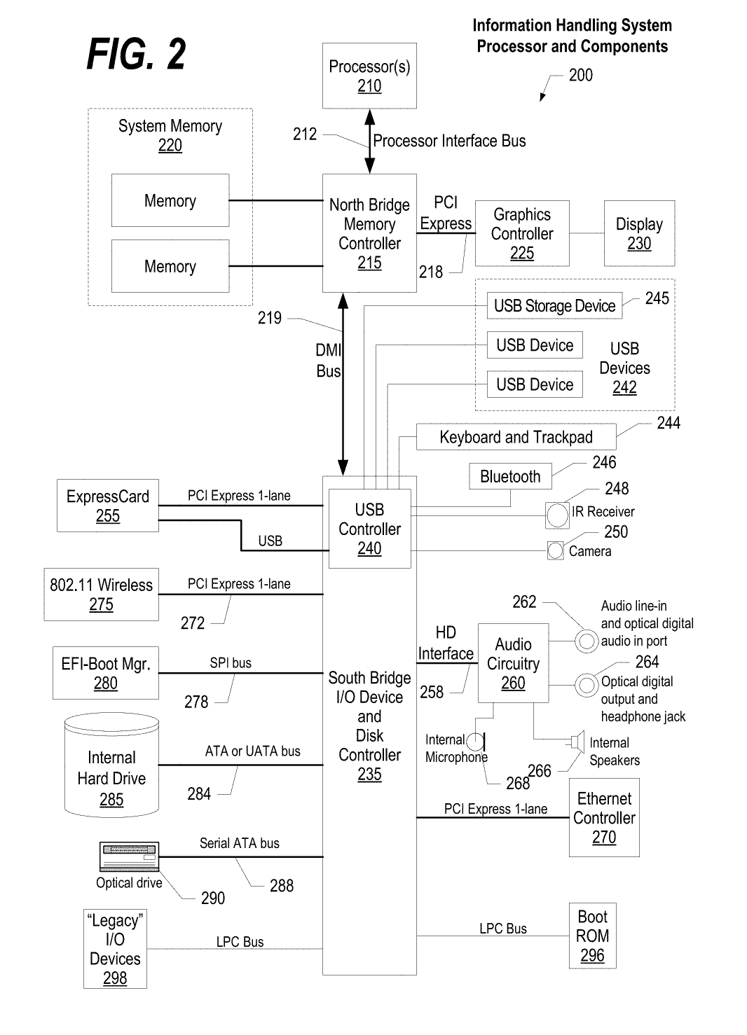

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

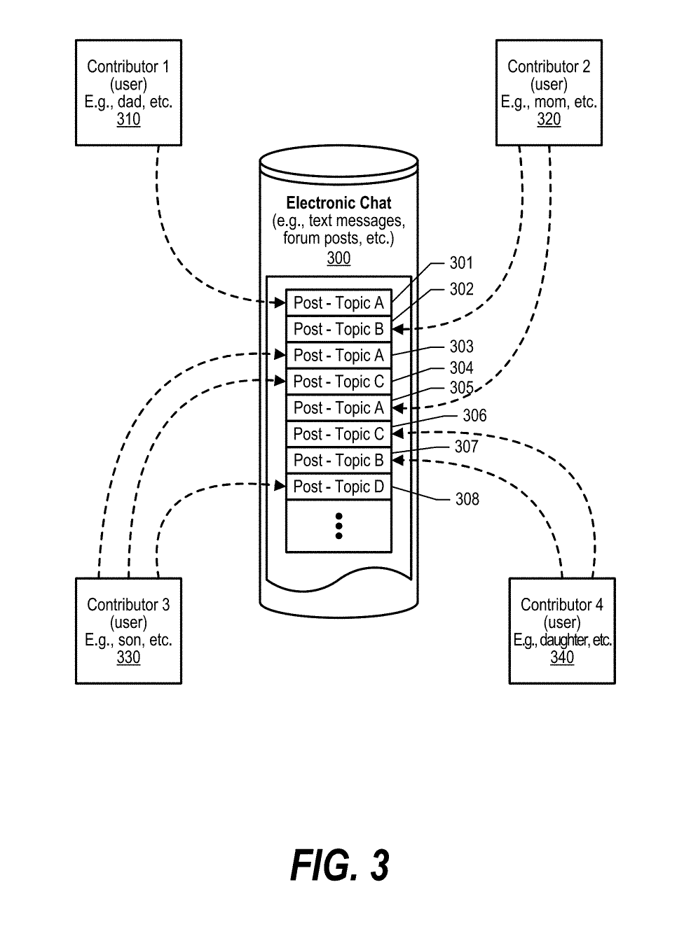

FIG. 3 is a diagram system interaction diagram depicting interaction between electronic message contributors and an electronic chat system. Electronic message dialog 300 shows a number of electronic messages that have been transmitted between any number of users in a chat group. Dialog 300 is stored in a common storage area on each of the devices used by the users in the chat group. In the example shown, various messages are shown between members of a family (mom, dad, daughter, and son). Based on the context, or topic, of the message, the contents may only be of interest to certain members of the family, but rather than setting up many different dialogs between all permutations of the family members, the users create dynamic, topic-oriented, sub-groups automatically based on the topic.

As shown, the various users (dad 310, mom 320, son 330, and daughter 340) are conversing about a variety of topics with individual messages 301 through 308. However, four different topics are currently being discussed (A through D) with D being a new topic that has just recently been initiated. Rather than having to sift through all of the messages to find messages of importance to a particular user, the processes described herein automatically identify the various topics of conversation and provide a user interface that provides a topical view of the conversations, rather than a detailed list of each message with little to no context for the individual messages.

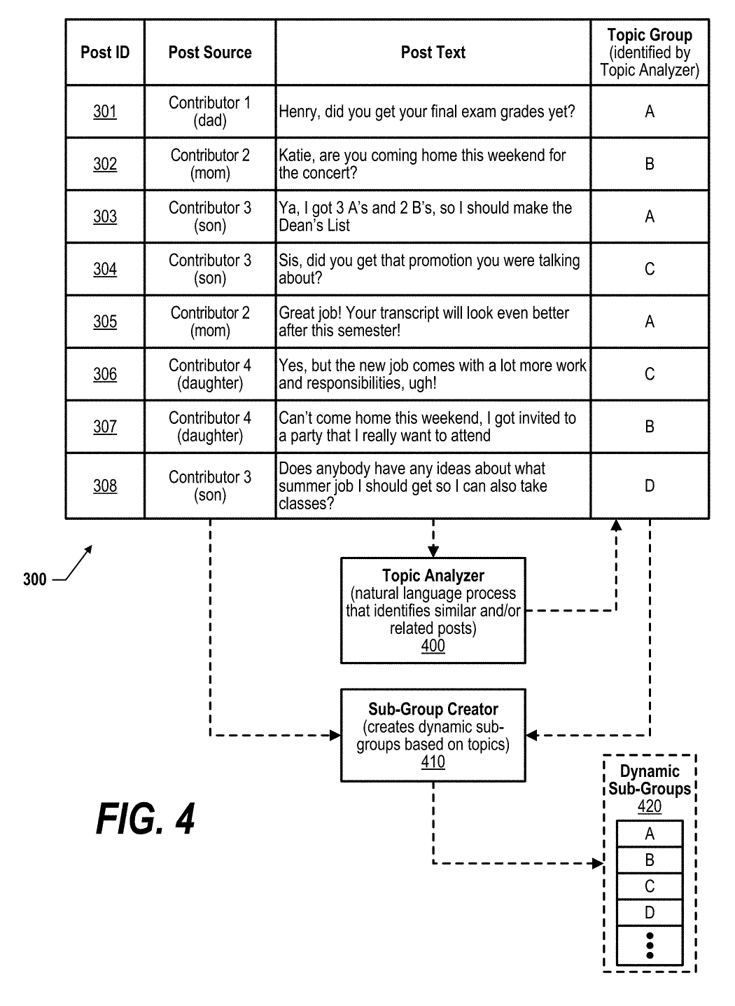

FIG. 4 is a diagram depicting functions of the topic analyzer and sub-group creator. Electronic message dialog 300 is shown with detail regarding the individual messages. Topic ‘A’ centers around discussions between the parents and the son regarding the son's grades at school, topic ‘B’ centers around discussions with the daughter about weekend plans, topic ‘C’ centers around a possible job promotion for the daughter, and topic ‘D’ is a newly created topic (new message with a topic that does not fit in any of the existing topics) that centers around the son's search for summer job possibilities. Each of the messages might not be important to each of the users. However, with a standard dialog viewer, each viewer (user) would see all of the messages regardless of the importance or relevance to the individual user.

To address the standard dialog viewer shortcomings, the processes described herein perform topic analyzer function 400 that uses natural language processing (NLP) techniques to identify topics of individual electronic messages and group the various messages into topics (e.g., topics A through D, etc.). Sub-group creator 410 creates a visible topical dialog that groups messages regarding a particular topic and forms dynamic sub-groups 420. As will be shown in greater detail below, the user can now select a topic of interest in order to view and respond to messages regarding a particular topic.

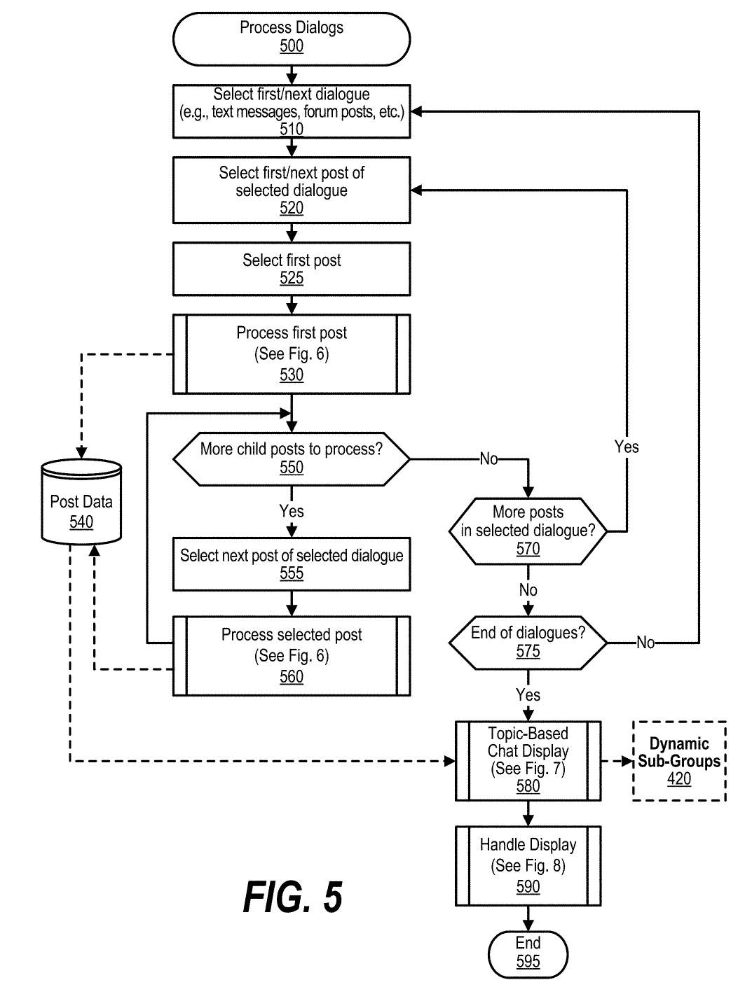

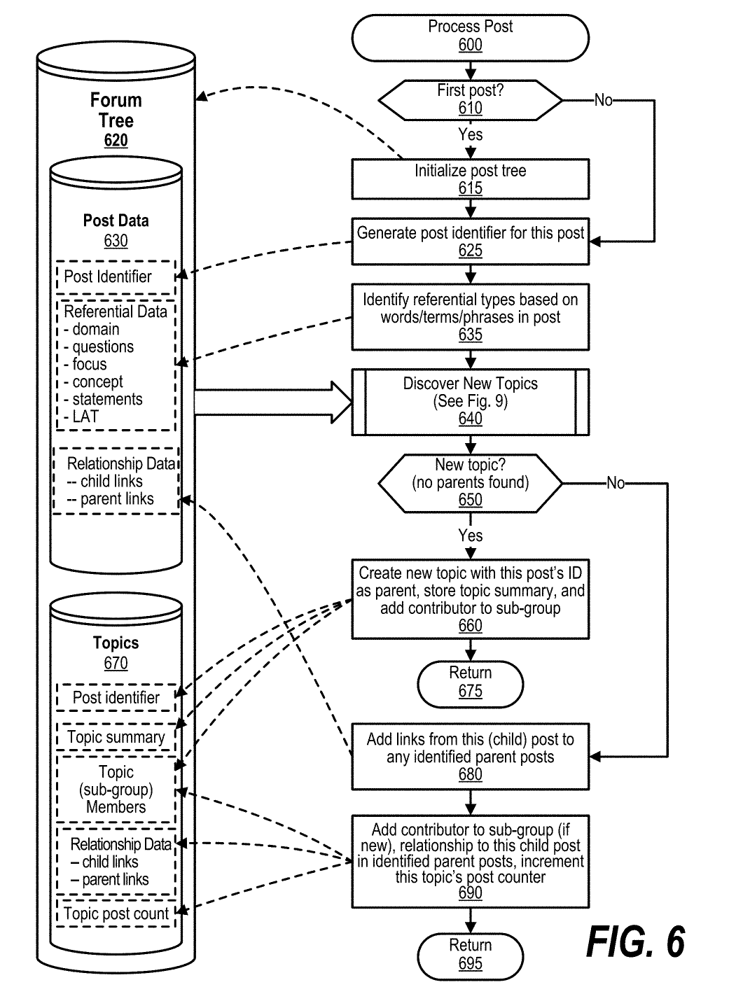

FIG. 5 is a flowchart showing steps taken to process dialogs found in electronic messaging systems. FIG. 5 processing commences at 500 and shows the steps taken by a process that process electronic message dialogs to create a topical-based viewer. At step 510, the process selects the first dialogue (e.g., text messages, forum posts, etc.). At step 520, the process selects the first post, or message, from the selected dialogue. At step 525, the process selects first post, and, at predefined process 530, the process performs the process first post routine (see FIG. 6 and corresponding text for processing details). The data resulting from the process first post routine is stored in data store 540.

The process determines as to whether there are child posts to process in the selected dialog (decision 550). If there are child posts to process in the selected dialog, then decision 550 branches to the ‘yes’ branch to loop through the child posts in the dialog using step 555 and predefined process 560. This looping continues until all of the child posts in the selected dialog have been processed, at which point decision 550 branches to the ‘no’ branch exiting the loop. At step 555, the process selects the next (child) post of selected dialog. At predefined process 560, the process performs the process selected post routine (see FIG. 6 and corresponding text for processing details) to process the selected child post and store the child post data in data store 540.

The process determines as to whether there are more posts in the selected dialog to process (decision 570). If there are more posts in the selected dialog to process, then decision 570 branches to the ‘yes’ branch which loops back to step 520 to select the next post in the dialog. This looping continues until there are no more posts to process from the selected dialog, at which point decision 570 branches to the ‘no’ branch exiting the loop. The process next determines as to whether the end of the dialogs on the user's device has been reached (decision 575). If the end of the dialogs on the user's device has been reached, then decision 575 branches to the ‘yes’ branch exiting the loop. On the other hand, if there are more dialog to process, then decision 575 branches to the ‘no’ branch which loops back to step 510 to select and process the next dialog from the user's device as described above.

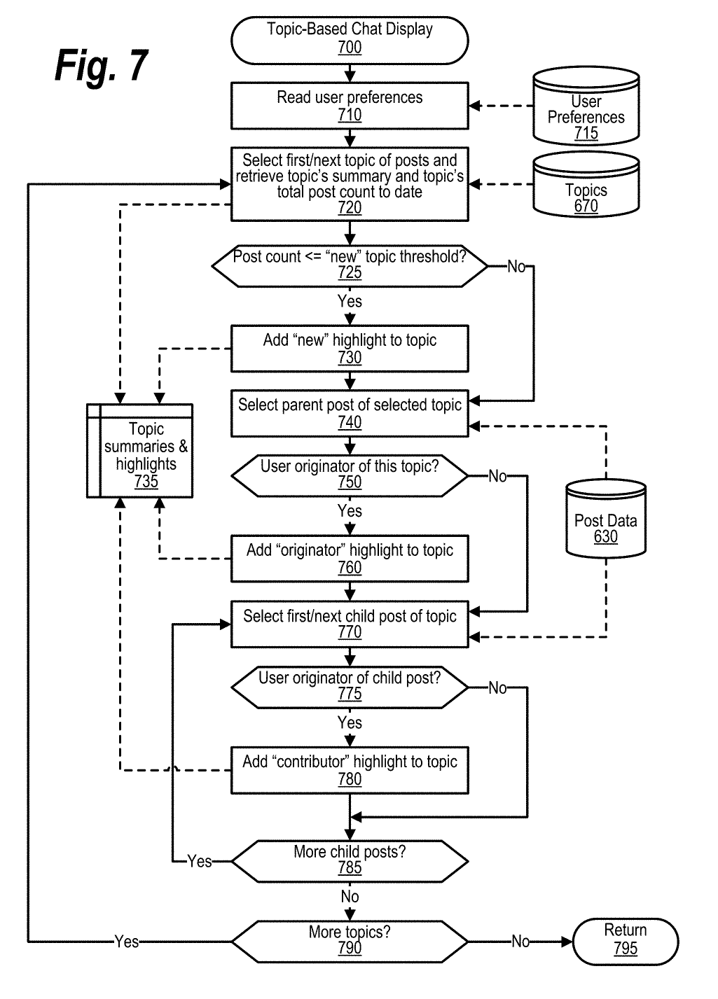

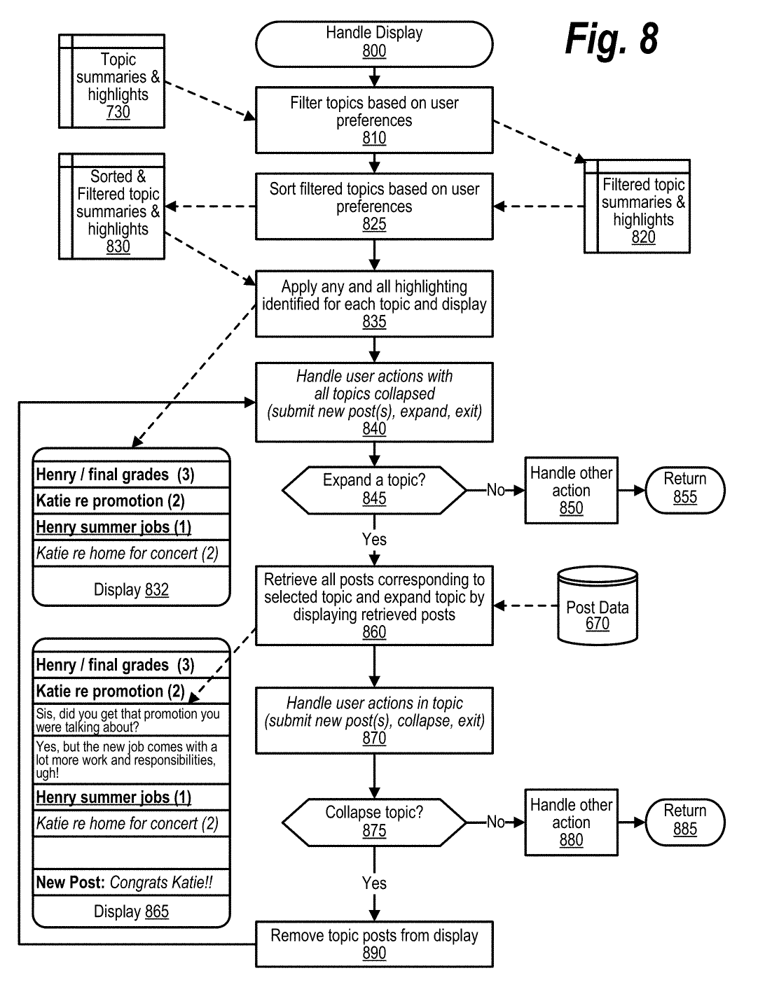

At predefined process 580, the process performs the topic-based chat display routine (see FIG. 7 and corresponding text for processing details). This routine automatically assigns the individual posts (messages) to topics and groups messages of the same topic. At predefined process 590, the process performs the handle display routine (see FIG. 8 and corresponding text for processing details). This routine manages the topical-based user interface displayed on the user's device. FIG. 5 processing thereafter ends at 595.

FIG. 6 is a flowchart showing steps taken to process a given post found in a dialog and create new topics and add posts to existing topics. FIG. 6 processing commences at 600 and shows the steps taken when processing a post retrieved from an electronic message dialog. The process determines as to whether the post being processed is the first post of the dialog (decision 610). If the post being processed is the first post of the dialog, then decision 610 branches to the ‘yes’ branch to perform step 615. On the other hand, if the post being processed is not the first post of the dialog, then decision 610 branches to the ‘no’ branch bypassing step 615. At step 615, the process initializes post tree 620 that is used to store data from electronic messages processed from the electronic message dialog. At step 625, the process generates a post identifier for the post and adds post data 630 to the post tree with the post data being initialized to store the newly generated post identifier.

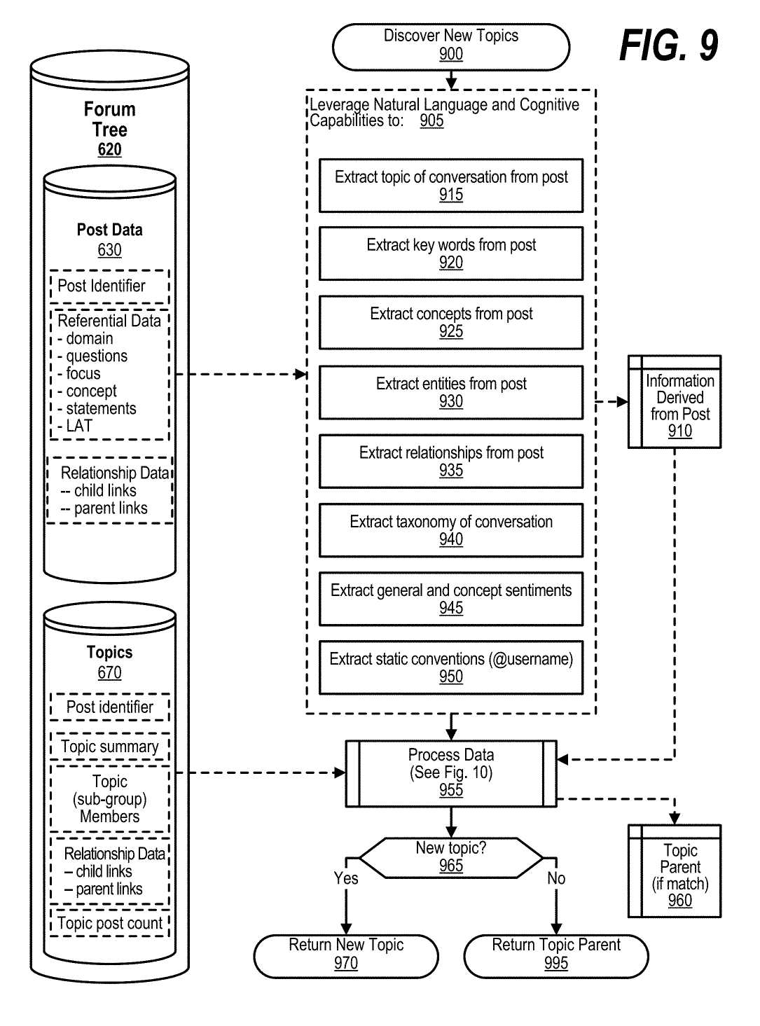

At step 635, the process identifies referential types based on words, terms, and phrases in post. As shown, referential data can include the domain of the electronic message, the question or questions posed in the electronic message, the focus of the electronic message, the concept of the electronic message, statements included in the electronic message, and the lexical answer type (LAT) of any question posed in the electronic message. At step 640, the process identifies any electronic messages that are parents to this electronic message with the parent messages already existing in the post tree (see FIG. 9 and corresponding text for further details).

The process next determines whether the topic, as defined by the referential data, is new topic to the electronic message dialog (decision 650). If the topic is a new topic, then decision 650 branches to the ‘yes’ branch to perform step 660. On the other hand, if the topic already exists in post tree 620, then decision 650 branches to the ‘no’ branch to perform steps 680 and 690. At step 660, the process creates a new topic with this post's identifier as the parent message of the topic. The process further stores the topic summary as defined by the referential data, and adds the user that posted the electronic message as a contributor to the topic as well as being the creator of the topic. FIG. 6 processing thereafter returns to the calling routine (see FIG. 5) at 675.

If the electronic message is not a new message, then steps 680 and 690 are performed. At step 680, the process adds links from this “child” post to any identified parent posts as well as adding links from any identified parent posts back to this child post. The links are added to post data store 630. At step 690, the process adds the user that posted this electronic message as a contributor to this topic (if such user has not already been included as a contributor). Step 690 further adds a relationship link to this child post in identified any identified parent posts, and increments this topic's post counter that keeps track of the number of electronic messages that are in this topic. FIG. 6 processing thereafter returns to the calling routine (see FIG. 5) at 695.

FIG. 7 is a flowchart showing steps that use the post processing to create topic summaries and highlights. FIG. 7 processing commences at 700 and shows the steps taken by a process that performs a topic-based chat display that creates topic summaries and adds appropriate highlights to topics in a dialog. At step 710, the process reads the user's preferences from data store 715. At step 720, the process selects the first topic of electronic messages and also retrieves the topic's summary and the topic's current total electronic message count to date. The topic summary and message count are stored in memory area 735.

The process determines as to whether the current number of electronic messages in the selected topic is lower than a given threshold that defines the number of messages in topics considered “new” (decision 725). If the current number of electronic messages in the selected topic is lower than the threshold, then decision 725 branches to the ‘yes’ branch to perform step 730. On the other hand, if the current number of electronic messages in the selected topic is not lower than the threshold, then decision 725 branches to the ‘no’ branch bypassing step 730. In one embodiment, an amount of time threshold can be applied either in conjunction with the message count threshold or in lieu of the message count threshold so that only topics that have been started within a certain amount of time (e.g., the past two days) are considered “new.” At step 730, in response to the topic being considered a “new” topic the process adds “new” highlight to topic and stores the new topic tag in memory area 735.

At step 740, the process selects the parent post of selected topic, such as the initial message that started the topic. The process determines as to whether this user is the originator of this topic (decision 750). If this user is the originator of this topic, then decision 750 branches to the ‘yes’ branch to perform step 760. On the other hand, this user is not the originator of this topic, then decision 750 branches to the ‘no’ branch bypassing step 760. At step 760, the process adds an “originator” highlight to topic and stores the originator topic tag in memory area 735.

At step 770, the process selects the first child post of topic. The process determines as whether this user is the originator (author) of the selected child post (decision 775). If this user is the originator of the selected child post, then decision 775 branches to the ‘yes’ branch to perform step 780. On the other hand, if this user is not the originator of the selected child post, then decision 775 branches to the ‘no’ branch bypassing step 780. At step 780, the process adds “contributor” highlight to topic and stores the contributor topic tag in memory area 735.

The process determines as to whether there are more child posts for the selected topic (decision 785). If there are more child posts for the selected topic, then decision 785 branches to the ‘yes’ branch which loops back to step 770 to select and process the next child post for the topic as described above. This looping continues until all of the child posts for the topic have been processed, at which point decision 785 branches to the ‘no’ branch exiting the loop. The process next determines whether there are more topics in the dialog to process (decision 790). If there are more topics in the dialog to process, then decision 790 branches to the ‘yes’ branch which loops back to step 720 to select and process the next topic in the dialog as described above. This looping continues until all of the topics in the dialog have been processed, at which point decision 790 branches to the ‘no’ branch exiting the loop. FIG. 7 processing thereafter returns to the calling routine (see FIG. 5) at 795.

FIG. 8 is a flowchart showing steps taken to handle the electronic messaging display that incorporates topic segregation. FIG. 8 processing commences at 800 and shows the steps taken by a process that handle display of topics for a dialog. At step 810, the process filters the topics in the dialog based on user preferences. Step 810 retrieves the topic data from memory area 730 and stores the filtered topic summaries and corresponding highlights in memory area 820. At step 825, the process sorts the filtered topics based on user preferences and stores the filtered topic summaries and corresponding highlights in memory area 830. At step 835, the process applies any and all highlighting identified for each topic and displays the sorted, filtered topic summaries on display screen 832.

At step 840, the process handles user actions that are received with all topics being in a collapsed state (e.g., actions of submit a new post, expand a selected topic, exit the dialog, etc.). The process determines as to whether the user has requested to expand a topic (decision 845). If the user has requested to expand a topic, then decision 845 branches to the ‘yes’ branch to perform step 860. On the other hand, if the user has not requested to expand a topic, then decision 845 branches to the ‘no’ branch whereupon step 850 is performed to handle some other action (e.g., new post, exit dialog, etc.) and processing returns to the calling routine at 855.

If the user has requested to expand a topic then, at step 860, the process retrieves all electronic messages included in the selected topic and expands the selected topic by displaying all of the retrieved electronic messages. The result of expanding one of the topics is depicted in the example shown in display 865. At step 870, the process handles user actions that are received with the selected topic being in an expanded state (e.g., actions of submit a new post, expand another topic, collapse a selected topic, exit the dialog, etc.).

The process determines as to whether the user has requested to collapse a topic that is currently shown in an expanded state (decision 875). If the user has requested to collapse a topic, then decision 875 branches to the ‘yes’ branch to perform step 890. On the other hand, if the user has not requested to collapse a topic, then decision 875 branches to the ‘no’ branch whereupon step 880 is performed to handle some other action (e.g., new post, exit dialog, etc.) and processing returns to the calling routine at 885. If the user has requested to expand a topic then, at step 890, the process removes the electronic messages included in the selected topic from display the display screen. Processing then loops back to step 840 to handle further user actions.

FIG. 9 is a flowchart showing steps taken to discover new topics that are discussed in an online discussion. FIG. 9 processing commences at 900 and shows the steps taken by a process that discovers new topics in an online discussion. At step 905, the process leverages natural language (NLS) and cognitive capabilities to extract a variety of information from the discussion data stored in data store 620. These extraction steps are detailed as steps 915 through 950 with the results of each of these extraction steps being stored in memory area 910. At step 915, the process extracts topic of conversation from post. At step 920, the process extracts key words from post. At step 925, the process extracts concepts from post. At step 930, the process extracts entities from post. At step 935, the process extracts relationships from post. At step 940, the process extracts a taxonomy of the conversation from the post. At step 945, the process extracts general and concept sentiments from the posts. At step 950, the process extracts static conventions from the posts, such as a username convention (e.g., “@<username>”, etc.).

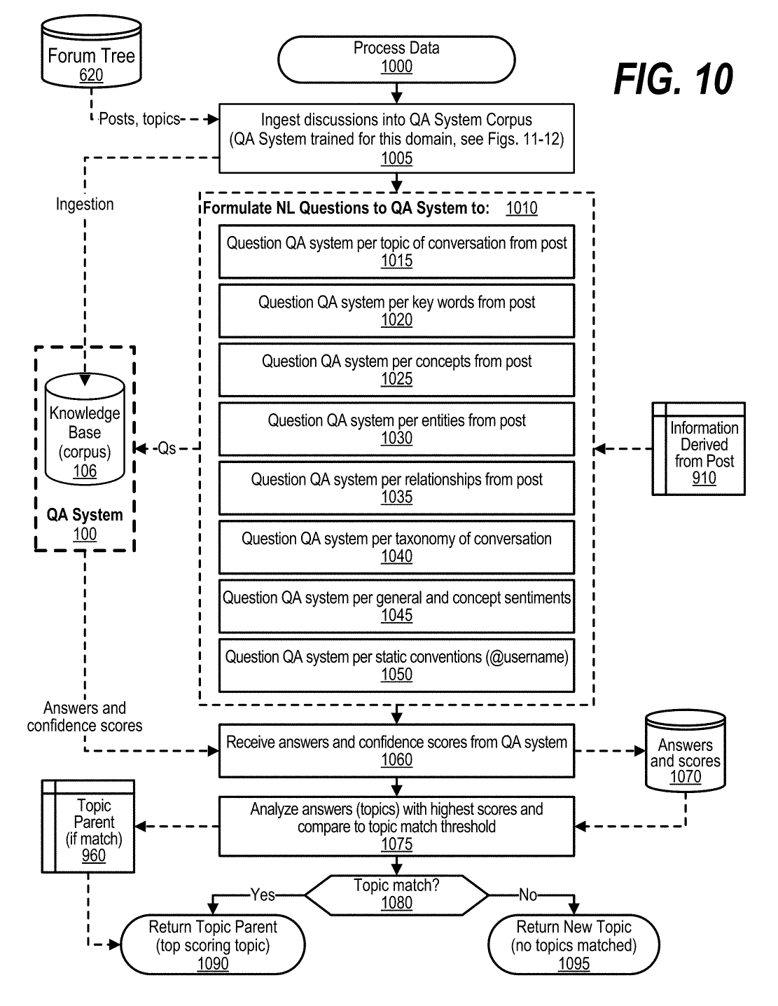

At predefined process 955, the process performs the Process Data routine (see FIG. 10 and corresponding text for processing details). This routine processes the data that was extracted from the posts and stored in memory area 910. The process determines as to whether the processing performed by predefined process 955 reveals that the post is a new topic (decision 965). If the post is a new topic, then decision 965 branches to the ‘yes’ branch whereupon processing returns to the calling routine at 970 with a return code indicating that the post represents a new topic to the discussion. On the other hand, if the post is not a new topic, then decision 965 branches to the ‘no’ branch whereupon processing returns to the calling routine at 995 with a return code indicating that the post belongs to an existing topic with a link stored in memory area 960 identifying the parent of the topic to which this post belongs.

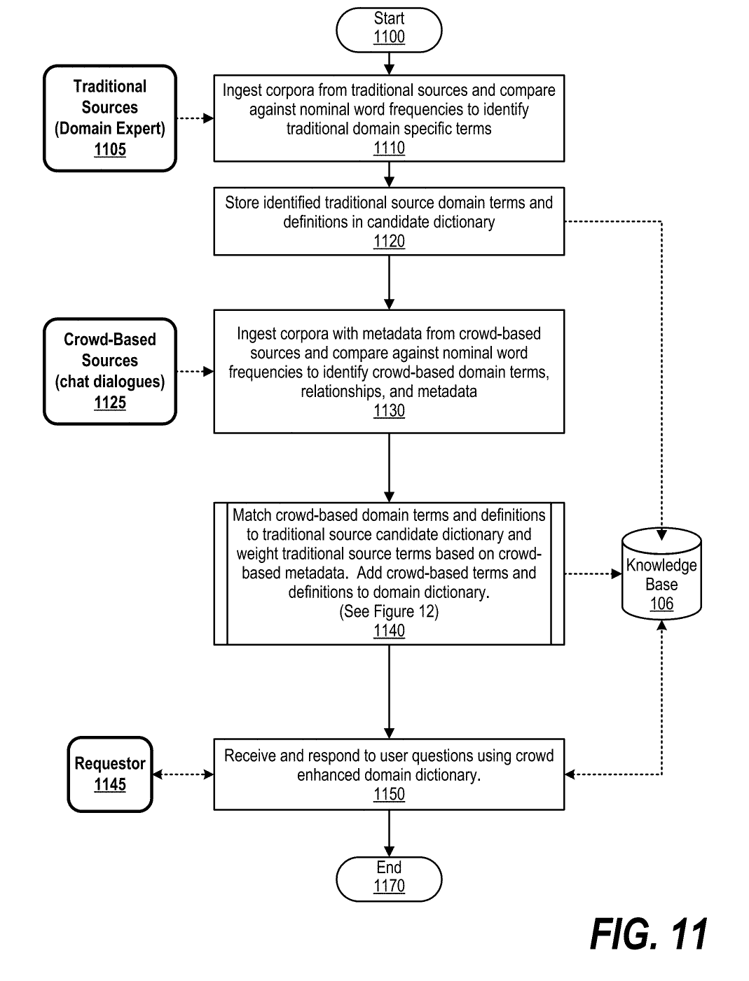

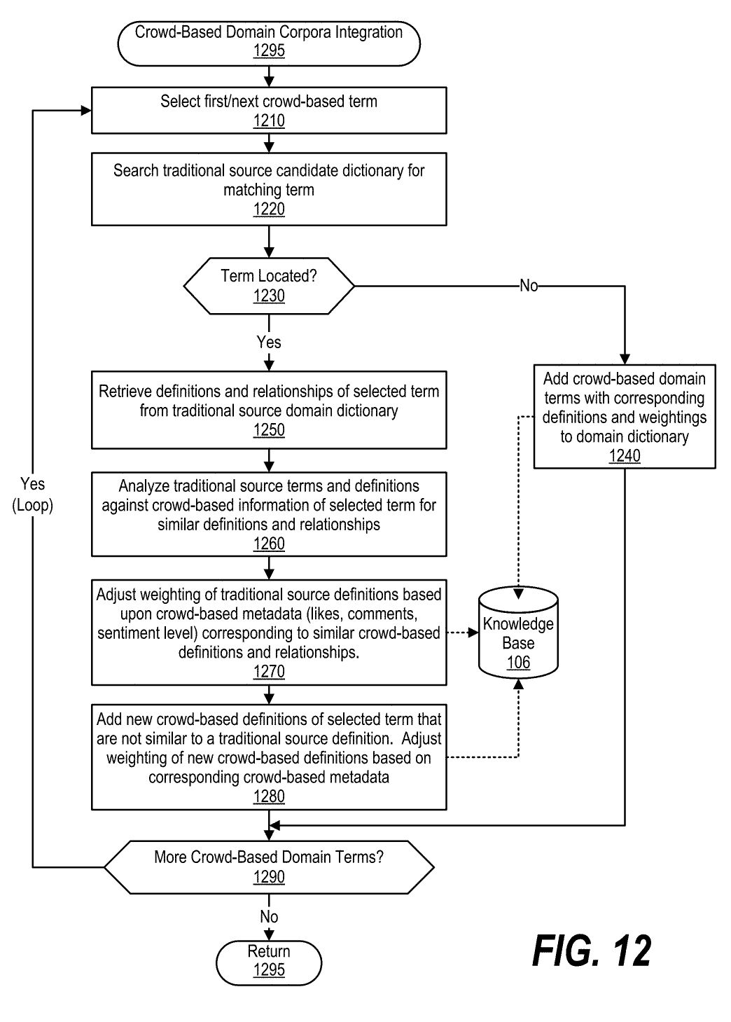

FIG. 10 is a flowchart showing steps taken to process data using a QA system to discover new topics that are discussed in an online discussion. FIG. 10 processing commences at 1000 and shows the steps taken by a process that processes the information derived from discussion posts to determine whether the post matches an existing topic already in the discussion or if the post represents a new topic being added to the discussion. At step 1005, the process ingests the discussions from data store 620 into QA System 100's corpus 106 (see FIGS. 11-12 for details regarding training the QA System trained for the domain corresponding to the discussion).

At step 1010, the process formulates numerous natural language questions to QA System 100 as set forth in sub-steps 1015 through 1050. Each of these questions is formulated using information that was derived from the posts in the discussion that is retrieved from memory area 910. At step 1015, the process poses natural language questions to QA system 100 regarding the topic of the conversations from post and other posts in the discussion for topic commonality. At step 1020, the process poses natural language questions to QA system 100 regarding the key words from post to find similarity between the post and other posts in the discussion. At step 1025, the process poses natural language questions to QA system 100 regarding the concepts from post to find commonality between the post's concepts and concepts found in other posts in the discussion. At step 1030, the process poses natural language questions to QA system 100 regarding the entities from post to find commonality between entities found in the post and entities found found in other posts in the discussion. At step 1035, the process poses natural language questions to QA system 100 regarding the relationships found between the post and other posts in the discussion. At step 1040, the process poses natural language questions to QA system 100 regarding the taxonomy of conversation in the post and the taxonomy of conversation in common with other posts. At step 1045, the process poses natural language questions to QA system 100 regarding the general and concept sentiments to find commonalities to general and concept sentiments found in other posts in the discussion. At step 1050, the process poses natural language questions to QA system 100 regarding the static conventions found in the post and static conventions found in other posts in the discussion. For example, a user name callout convention (e.g., “@username”, etc.) might be found in the post as well as in other posts in the discussion.

At step 1060, the process receives answers and confidence scores from QA system 100 with these answers being responsive to the questions posed to QA system 100 in steps 1015 through 1050. The answers and scores received from QA system 100 are stored in data store 1070. At step 1075, the process analyzes the answers received from QA system 100 with these answers being based on topics that are found in the post and the discussion with the analysis taking into account the highest scores of the answers and also comparing the scores to a topic match threshold. If a topic match is found, then step 1075 stores the topic match in memory area 960. Based on the analysis performed at step 1075, the process determines whether a topic match was found between the post and other posts in the discussion (decision 1080). If a topic match was found, then decision 1080 branches to the ‘yes’ branch whereupon the process returns the top scoring topic match to the calling routine at 1090 (see FIG. 9). On the other hand, if a topic match was not found, then decision 1080 branches to the ‘no’ branch whereupon the process returns not topic match to the calling routine at 1095 (see FIG. 9), thus indicating that the post represents a new topic being added to the discussion.

FIG. 11 is an exemplary flowchart showing steps by a question/answer system to ingest traditional corpora into a domain dictionary and enhance the domain dictionary based upon crowd-based metadata. Processing commences at 1100, whereupon at step 1110, the process ingests corpora from traditional sources 1105, such as an expert regarding the domain, and compares the traditional corpora against nominal word frequencies to identify traditional domain specific terms. For example, the QA system may be training for an “Economics” domain and ingests corpora from economics books and journals. in this example, the QA system identifies economic terms in the economics books and journals that are utilized more often when compared against common documents such as newspapers, novels, etc. At step 1120, the process stores the identified traditional source domain terms and definitions in a domain dictionary located in knowledge base 106.

The process, at step 1130 ingests crowd-based corpora with crowd-based metadata from crowd-based sources 1125, such as discussion dialogues and the like, and compares the crowd-based corpora against nominal word frequencies to identify crowd-based domain terms, relationships, and metadata. Continuing from the example above, the QA system may ingest information from a financial newsfeed and identify terms that the QA system utilizes more often when compared against common documents.

At predefined process 1140, the process matches crowd-based domain terms and definitions to traditional source candidate dictionary terms and weighs the traditional source terms based on the crowd-based metadata (see FIG. 12 and corresponding text for processing details). In addition, the process augments the domain dictionary by adding unique crowd-based terms and definitions. Continuing with the example above, the QA system may determine that the term “social return on investment” is a crowd-based term that does not match a traditional term. As such, the QA system adds “social return on investment” and corresponding definitions to the domain dictionary.

At this point, the QA system is ready to provide time sensitive answers to domain specific questions. As such, at step 1150, the process receives a question from requestor 1145 that includes question terms. The process evaluates the question terms against the terms and weightings included in crowd enhanced domain dictionary to provide an answer to requestor 1145. Processing thereafter ends at 1170.

FIG. 12 is an exemplary flowchart showing steps by a question/answer system to augment, influence, and define traditional source domain terms based on crowd-based metadata and crowd-based information. Processing commences at 1200, whereupon at step 1210, the process selects a first crowd-based term from domain specific crowd-based data, which is crowd-based corpora that the process filters to a specific domain.

At step 1220, the process searches the traditional source domain dictionary for a term that matches the selected crowd-based term (e.g., “fiscal”). The process determines as to whether the traditional source domain dictionary includes a matching traditional term (decision 1230). If the traditional source domain dictionary does not include a matching term, then decision 1230 branches to the ‘no’ branch. At step 1240, the process adds the selected crowd-based domain term with corresponding definitions and weightings to the domain dictionary located in knowledge base 106 (e.g., “fiscal cliff”).

On the other hand, if a matching traditional term is located, then decision 1230 branches to the ‘yes’ branch. At step 1250, the process retrieves definitions and relationships of the selected term from traditional source candidate dictionary. At step 1260, the process analyzes the traditional source terms and definitions against crowd-based information of the selected term for similar definitions and relationships. At step 1270, the process adjusts weighting of the traditional source definitions based upon the crowd-based metadata corresponding to similar crowd-based definitions and relationships (crowd-based definition rankings). For example, the QA system may apply a higher weighting to the definitions of the terms corresponding to the most crowd influenced value based on the crowd-based metadata such as “likes,” “follows,” “tags,” “tag-weights,” etc.

At step 1280, the process adds new crowd-based definitions of the selected term that are not similar to a traditional source definition. For example, the traditional source domain dictionary may include four definitions for the term “fiscal,” and the domain specific crowd-based data may include an additional recent term that the QA system adds to the domain dictionary. The process then adjusts the weightings of new crowd-based definitions based on corresponding crowd-based metadata.

The process determines as to whether there are more crowd-based domain terms to evaluate against traditional terms (decision 1290). If there are more crowd-based domain terms to evaluate, then decision 1290 branches to the ‘yes’ branch to select and process the next crowd-based term. This looping continues until there are no more crowd-based terms to process, at which point decision 1290 branches to the “no” branch. FIG. 12 processing thereafter returns to the calling routine (see FIG. 11) at 1295.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
transmitting a plurality of electronic messages (posts) between a plurality of users, wherein the plurality of posts are directed to a discussion stored in a storage area;
identifying a plurality of topics corresponding to the plurality of posts, wherein the identifying is performed by:
ingesting the plurality of electronic messages into a question answering (QA) system;
deriving a set of information from the posts;
after the ingesting, posing a plurality of questions to the QA system, wherein the questions are directed at topic commonality between the plurality of posts;
analyzing a plurality of responses and corresponding scores received from the QA system, wherein the analysis matches a topic found in a selected one of the plurality of posts with the topic also found in a set of one or more other posts; and
displaying, on a display screen, the plurality of topics at a selected one of the plurality of devices that is utilized by a selected one of the plurality of users.

2. The method of claim 1 further comprising:
extracting a plurality of topic oriented data from the selected post;
formulating at least one of the plurality of questions to ask the QA system which of the plurality of posts match the plurality of topic oriented data extracted from the selected post; and
determining the plurality of topics based on the scores returned by the QA system.

3. The method of claim 2 wherein at least one of the topic oriented data pertains to a static convention found in the selected post.

4. The method of claim 2 wherein at least one of the topic oriented data pertains to one or more key words found in the selected post.

5. The method of claim 2 wherein at least one of the topic oriented data pertains to one or more entities referenced in the selected post.

6. The method of claim 2 wherein at least one of the topic oriented data is selected from the group consisting of a topic of conversation found in the selected post, a concept found in the selected post, a relationship referenced in the selected post, a taxonomy of a conversation found in the selected post, and a sentiment found in the selected post.

7. The method of claim 1 further comprising:
establishing a new topic based on the selected post in response to the analyzing resulting in no topic matches to the plurality of posts.

8. An information handling system comprising:
one or more processors;
a memory coupled to at least one of the processors;
a computer network that connects the information handling system to a plurality of other information handling systems, collectively forming a plurality of devices;
a display screen accessible by at least one of the processors; and
a set of computer program instructions stored in the memory and executed by at least one of the processors in order to perform actions comprising:
transmitting a plurality of electronic messages (posts) between a plurality of users, wherein the plurality of posts are directed to a discussion stored in a storage area;
identifying a plurality of topics corresponding to the plurality of posts, wherein the identifying is performed by:
ingesting the plurality of electronic messages into a question answering (QA) system;
deriving a set of information from the posts;
after the ingesting, posing a plurality of questions to the QA system, wherein the questions are directed at topic commonality between the plurality of posts;
analyzing a plurality of responses and corresponding scores received from the QA system, wherein the analysis matches a topic found in a selected one of the plurality of posts with the topic also found in a set of one or more other posts; and
displaying, on a display screen, the plurality of topics at a selected one of the plurality of devices that is utilized by a selected one of the plurality of users.

9. The information handling system of claim 8 wherein the actions further comprise:
extracting a plurality of topic oriented data from the selected post;
formulating at least one of the plurality of questions to ask the QA system which of the plurality of posts match the plurality of topic oriented data extracted from the selected post; and
determining the plurality of topics based on the scores returned by the QA system.

10. The information handling system of claim 9 wherein at least one of the topic oriented data pertains to a static convention found in the selected post.

11. The information handling system of claim 9 wherein at least one of the topic oriented data pertains to one or more key words found in the selected post.

12. The information handling system of claim 9 wherein at least one of the topic oriented data pertains to one or more entities referenced in the selected post.

13. The information handling system of claim 9 wherein at least one of the topic oriented data is selected from the group consisting of a topic of conversation found in the selected post, a concept found in the selected post, a relationship referenced in the selected post, a taxonomy of a conversation found in the selected post, and a sentiment found in the selected post.

14. The information handling system of claim 8 wherein the actions further comprise:
establishing a new topic based on the selected post in response to the analyzing resulting in no topic matches to the plurality of posts.

15. A computer program product stored in a computer readable storage medium, comprising computer program code that, when executed by an information handling system, performs actions comprising:
transmitting a plurality of electronic messages (posts) between a plurality of users, wherein the plurality of posts are directed to a discussion stored in a storage area;
identifying a plurality of topics corresponding to the plurality of posts, wherein the identifying is performed by:
ingesting the plurality of electronic messages into a question answering (QA) system;
deriving a set of information from the posts;
after the ingesting, posing a plurality of questions to the QA system, wherein the questions are directed at topic commonality between the plurality of posts;
analyzing a plurality of responses and corresponding scores received from the QA system, wherein the analysis matches a topic found in a selected one of the plurality of posts with the topic also found in a set of one or more other posts; and
displaying, on a display screen, the plurality of topics at a selected one of the plurality of devices that is utilized by a selected one of the plurality of users.

16. The computer program product of claim 15 wherein the actions further comprise:
extracting a plurality of topic oriented data from the selected post;
formulating at least one of the plurality of questions to ask the QA system which of the plurality of posts match the plurality of topic oriented data extracted from the selected post; and
determining the plurality of topics based on the scores returned by the QA system.

17. The computer program product of claim 16 wherein at least one of the topic oriented data pertains to a static convention found in the selected post.

18. The computer program product of claim 16 wherein at least one of the topic oriented data pertains to one or more key words found in the selected post.

19. The computer program product of claim 16 wherein at least one of the topic oriented data pertains to one or more entities referenced in the selected post.

20. The computer program product of claim 15 wherein the actions further comprise:
establishing a new topic based on the selected post in response to the analyzing resulting in no topic matches to the plurality of posts.
